(19) United States
(12) Patent Application Publication
(10) Pub. No.: US 2003/0179531 A1
(43) Pub. Date: Sep. 25, 2003

(54) Application server, communications adapter and control method

(75) Inventor: Kotaro Yamaguchi, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/389,949

(22) Filed: Mar. 18, 2003

(30) Foreign Application Priority Data
Mar. 19, 2002 (JP) 2002-077072

(51) Int. Cl. H01H 73/00

(52) U.S. Cl. 361/115

(57) ABSTRACT

Data input into an information input apparatus is uploaded to an application server on a network via a communications adapter and downloaded to the image input apparatus from the network application server via the communications adapter in response to a user request. The upload of data input to the image input apparatus to the network application server via the communications adapter involves small data size data (thumbnail data). Original data corresponding to the uploaded small data size data may then be uploaded to the network application server upon user request, the original data then being downloaded to the image input apparatus via the communications adapter from the network application server.

### FIELD OF THE INVENTION

The present invention relates to an application server, a communications adapter and control method for controlling the application server and communications adapter in order to transmit data between a communications adapter and an application server via a network.

### BACKGROUND OF THE INVENTION

Conventionally, there are personal computers (hereinafter PC) and digital cameras with built-in communications adapters in which the digital camera or other such image input device uses either a Universal Serial Bus (hereinafter USB) or wireless communications (such as infrared or Bluetooth systems) to read image data accumulated in the digital camera internal memory or in recording media such as a Compact Flash card (CF card) or Secure Digital memory card (SD memory card) that are stored inside the digital camera. These conventional image input devices can be connected to a server on the Internet so as to image data to the server or to a storage device connected to the server. The image data uploaded to the Internet server can then be viewed and/or downloaded by a PC or a cell phone equipped to access the server via the Internet.

In order to once again download to the digital camera the image data that has been uploaded to the server, the same high-resolution image data as obtained originally (hereinafter original image data) is often required, whereas by contrast low-resolution image data (hereinafter also referred to as thumbnail image data) is often adequate for just viewing the image data.

However, conventionally, original image data is uploaded without regard to the use or application of the image data, that is, whether original image data is required or thumbnail image data will suffice. Accordingly, since the data size of original image data is very much greater than that of thumbnail image data, the conventional procedure results in sometimes unnecessarily long and costly transmissions.

### SUMMARY OF THE INVENTION

Accordingly, the present invention has been conceived in light of the foregoing considerations, and has as its object to provide an application server adapted to provide a service for storing and viewing images on a network, the application server comprising: a receiver adapted to receive first data from a communications adapter via a network; a selection unit adapted to select one or more first data from among the first data received for viewing by a service user; and an instruction unit for instructing the communications adapter to transmit to the application server second data corresponding to the first data selected by the selection unit, wherein the data size of the first data is smaller than the data size of the second data.

In addition, the above-described object of the present invention is also achieved by a method of providing a service for storing and viewing images on a network, the method comprising the steps of: receiving first data from a communications adapter via a network; selecting one or more first data from among the first data received for viewing by a service user; and instructing the communications adapter to transmit to an application server second data corresponding to the first data selected in the selection step, wherein the data size of the first data is smaller than the data size of the second data.

Other objects, features, effects and advantages of the present invention will be apparent from the following description, taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention, in which:

FIG. 1 is a schematic diagram of a network system according to one embodiment of the present invention;

FIG. 2 shows an example of a setting screen for an application for setting the settings of a PC according to the present invention;

FIG. 3 is an oblique schematic view of the communications adapter of the present invention;

FIG. 4 is a schematic diagram of the internal structure of the communications adapter of the present invention;

FIG. 5 is a diagram showing the structure of the software for wireless communications control inside the communications adapter of the present invention;

FIG. 6 is a flow chart showing steps in the process of uploading image data to a network server using the communications adapter of the present invention;

FIG. 7 is a schematic diagram of the area for managing user information and image data held in the server in the present invention;

FIG. 8 is a schematic diagram of the internal structure of the image data area of the present invention;

FIG. 9 shows an example of a display screen displaying on a PC monitor image data stored in the server image data area in the present invention;

FIG. 10 is a flow chart showing steps in a process of downloading image data to a digital camera from a server by the communications adapter of the present invention;

FIG. 11 is a schematic diagram of the internal structure of the image data area according to one embodiment of the present invention;

FIG. 12 shows an example of a display screen displaying on a PC monitor image data stored in the server image data area in the present invention; and

FIG. 13 is a flow chart showing steps in a process of uploading image data to a network server using the communications adapter of the present invention.

### DETAILED DESCRIPTION OF THE PREFERRED EMBODIMENTS

Preferred embodiments of the present invention will be described in detail in accordance with the accompanying drawings.

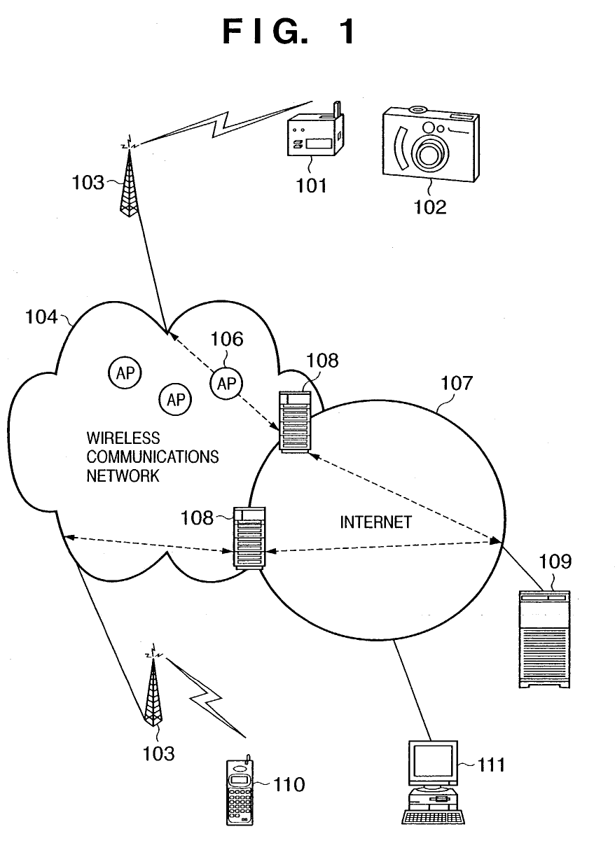

FIG. 1 is a schematic diagram of a network system according to one embodiment of the present invention. That is, FIG. 1 shows schematically the connections between a communications adapter 101, a digital camera 102, antennas 103, a wireless communications network 104, an Internet network 107, a server 109, a wireless communications terminal 110 and a PC 111.

As shown in FIG. 1, multiple Access Points (AP) 106 which are provided by an Internet Service Provider (hereinafter ISP) exist within the wireless communications network 104, with the communications adapter 101 accessing the wireless communications network 104 via the nearest base station 103 and making a dial-up connection from one of the AP 106. The AP 106 then further connects the dial-up connection communication session to the Internet 107 via a gateway 108, thereby establishing communications between the communications adapter 101 and the Internet 107.

At the same time, in the example shown in FIG. 1, the communications adapter 101 is connected to the digital camera 102 via a USB interface and acquires the image data in the digital camera 102. In addition, in the Internet 107 server the Word Wide Web (WWW) server application is activated, and at the point at which communications are established between the communications adapter 101 and the Internet 107, the read-out image data is uploaded to the server 109 using a communications protocol such as Hyper Text Transfer Protocol (HTTP).

Incidentally, the connection from the wireless communications terminal 110 to the Internet 107 is accomplished by connecting to the wireless communications network 104 operated by a telecommunications carrier from the wireless communications terminal 110 via the nearest base station. Typically, a Web browser is installed and operating on the wireless communications terminal 110, and when a connection to the Internet 107 is established it is possible to communicate with the server 109 using HTTP or the like.

Similarly, from a Web browser running on the PC 111 connected to the Internet 107 using an ISP or the like, it is possible to communicate with the server using HTTP. The Web browser can then be used to view the image data uploaded to the server 109, and further, to download that image data to the PC 111.

As described above, in order to make a dial-up connection to one of the multiple AP 106 existing within the wireless communications network 104, the communications adapter 101 retains dial-up connection data consisting of the AP 106 telephone number, the user name and password used to log in to the internet connection service offered by the ISP, and so forth. The communications adapter 101 uses this internally stored data to effect a dial-up connection by dialing the telephone number. In addition, when accessing the Internet 107 server 109, normally the user ID and password are needed to access the server, so these values, too, are stored as data.

In addition, the above-described data is set to the communications adapter 101 using the setting application running on the PC. Typically, in order to hold down costs, the communications adapter 101 is not provided with complicated setting input means, so there is no way to input strings of alphanumeric characters such as telephone numbers and user names from the communications adapter 101. Accordingly, such alphanumeric character string input is carried out using a keyboard attached to a computer, with the communications adapter 101 being attached to the computer.

That is, in the network system of the present embodiment, a communications adapter 101 not equipped with either a Web browser or image selection controls is used to upload image data from the digital camera 102 to the Internet 107 server 109, so that image data from the server 109 can be downloaded by a Web browser-equipped PC 111.

It should be noted that, although the present embodiment assumes the use of a digital camera, the object of the present invention can be achieved not only by using a digital camera but also by using an image input apparatus such as a scanner or the like.

In addition, the wireless communications terminal 110 may be a cell phone, PDA or the like.

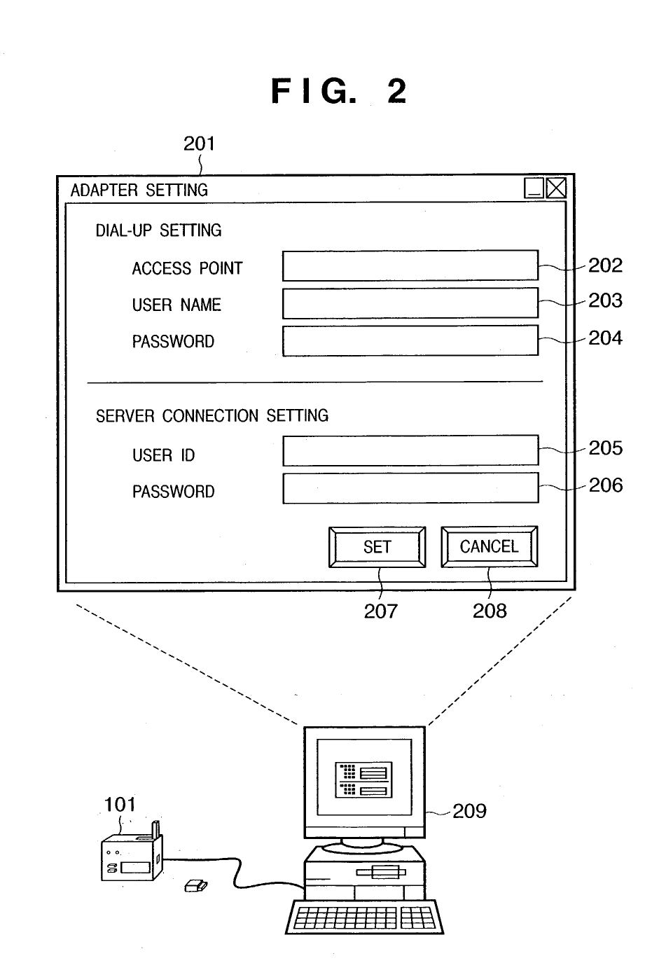

FIG. 2 shows an example of a setting screen for an application for setting the settings of a PC according to the present invention. Here, a user uses a PC keyboard to input desired inputs into the dialog boxes (e.g., the AP 202, user name 203, password 204, user ID 205, password 206, etc.) of the setting screen 201, after which the user presses the set button 207. When the set button 207 is pressed, this setting application sets the above-described input data, as well as the date and time, for the communications adapter 101 connected to a PC 209 via a USB interface or the like. Typically, the settings are set in such a way that the telephone number that the user sets in the AP dialog box 202 is the telephone number of the AP 106 that is nearest (or accessible within the same local calling area) to the location where the communications adapter 101 is used, because most of the communication charges incurred when communicating with the Internet 107 server 109 from the communications adapter 101 are attributed to the charge from the nearest base station to the AP 106. Accordingly, these call charges can be minimized by selecting the nearest available AP 106.

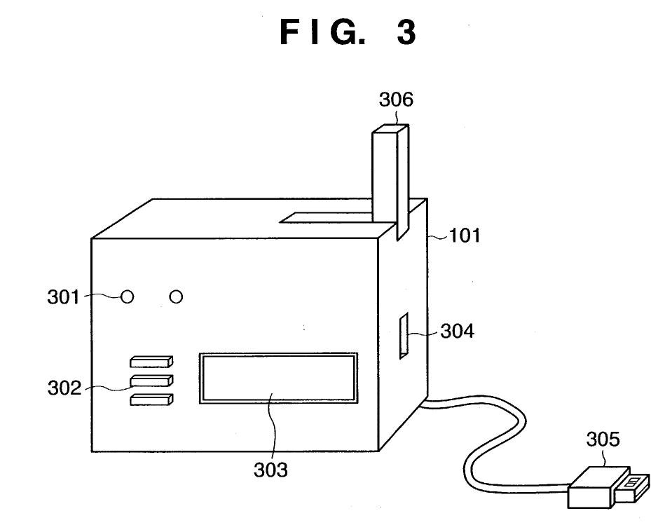

FIG. 3 is an oblique schematic view of the communications adapter of the present invention.

As shown in FIG. 3, Light Emitting Diodes (LEDs) 301 consisting of green and red lights are provided to inform the user of the operating status of the communications adapter 101. Controls 302 enable the user to turn the communications adapter 101 ON or OFF, to upload the image data inside the digital camera 102 to the server 109, or, conversely, to download image data from the server 109. A Liquid Crystal Display (LCD) 303 displays information concerning the operating status of the communications adapter 101, battery power, settings and the like. A connector 304 is in this case a USB connector for connecting the PC 209 with the communications adapter 101. By using the connector 304 to connect the communications adapter 101 and the PC 209 to each other via a USB cable 305, the PC 209 operates as a USB host and the communications adapter 101 operates as a USB device. As a result, as described above, the user can then set the AP telephone number, US ID, password and so forth directly from the PC 209.

As noted previously, the connector cable 305 is a USB connector cable for connecting a USB device such as a digital camera 102. By using the connector cable 305 to connect the digital camera 102 and the communications adapter 101 to each other, the communications adapter 101 operates as a USB host and the digital camera 102 operates as a USB device, so that the user can then access image data in the digital camera 102 from the communications adapter 101. An antenna 306 is used to transmit and receive radio waves for the purpose of communications with the wireless communications network 104 via a wireless base station 103.

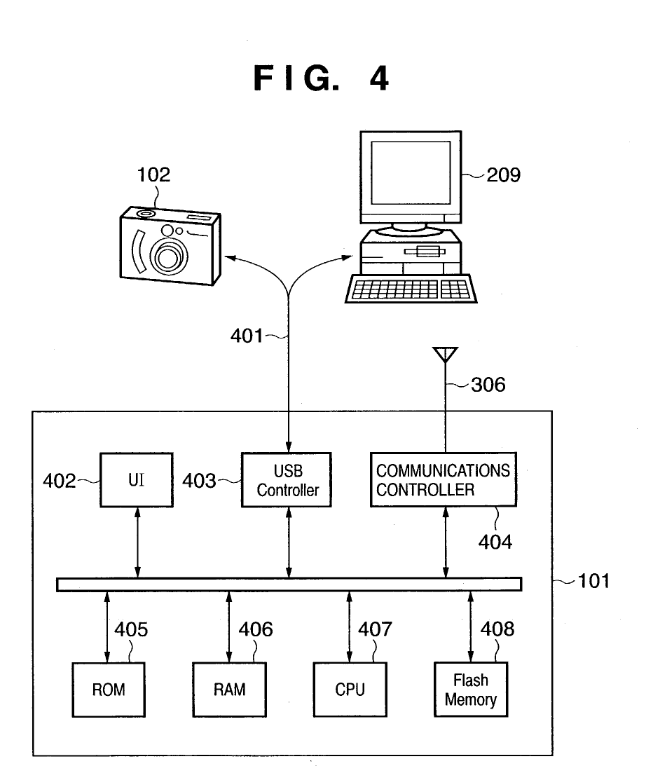

FIG. 4 is a schematic diagram of the internal structure of the communications adapter of the present invention. A User Interface (UI) controller 402 controls the operating system hardware, that is, controls the LED 301 lighting and the LCD 303 display and detects when the controls 302 have been pressed. A USB controller 403 controls communications between the digital camera 102 and the PC 209 which are connected to each other by a USB cable 401, communicating device control data and image data. A communications controller 404 controls communications with the wireless communications network 104 via the wireless base station 103. The protocols used for these communications may be Code Division Multiple Access (cdmaOne), Wide Band Code Division Multiple Access (W-CDMA), Personal Handy phone System (PHS) or the like.

A Read Only Memory (ROM) 405 holds a program that exerts overall control of the operations of the communications adapter 101. A Central Processing Unit (CPU) 407 reads and executes the program, using a Random Access Memory (RAM) 406 as a work area. A Flash Memory 408 is a storage area for storing setting information needed for the operation of the communications adapter 101, which information remains in the memory even after power to the communications adapter 101 is turned OFF. As described with reference to FIG. 2 above, when setting the telephone number 202 of the AP 106, the user name 203, password 204, user ID 205 for logging into the server 109 and the password 206 in the communications adapter 101 using the setting use application running on the PC 209, such information is stored in the Flash Memory 408.

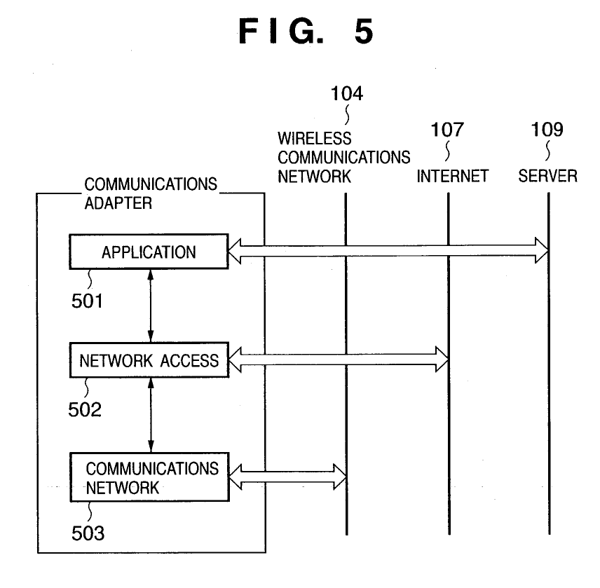

FIG. 5 is a diagram showing the structure of the software for wireless communications control inside the communications adapter of the present invention. As shown in FIG. 5, the Code Division Multiple Access (cdmaOne), Wide Band Code Division Multiple Access (W-CDMA) or Personal Handy phone System (PHS) communications protocols described above are supplied as a communications network access layer 503, controlling call origination, call reception, call disconnection and so forth for the purpose of connecting to the wireless communications network 104. On top of the communications network access layer 503 there is a network access layer 502, providing Point to Point Protocol (PPP) for making a dial-up connection to the Internet 107 and an Internet Protocol (IP) and a Transmission Control Protocol (TCP) needed for communication within the Internet 107. Further, there is an application layer 501 atop the network access layer 502, loading the HTTP and other protocol for transmitting data to and from the Internet 107 server 109.

By using the above-described communications adapter 101 connected to the digital camera 102, image data in the digital camera 102 can be uploaded to the Internet 107 server 109.

A description is now given of steps in the process of uploading image data in the digital camera 102 from the communications adapter 101 to the Internet 107 server 109.

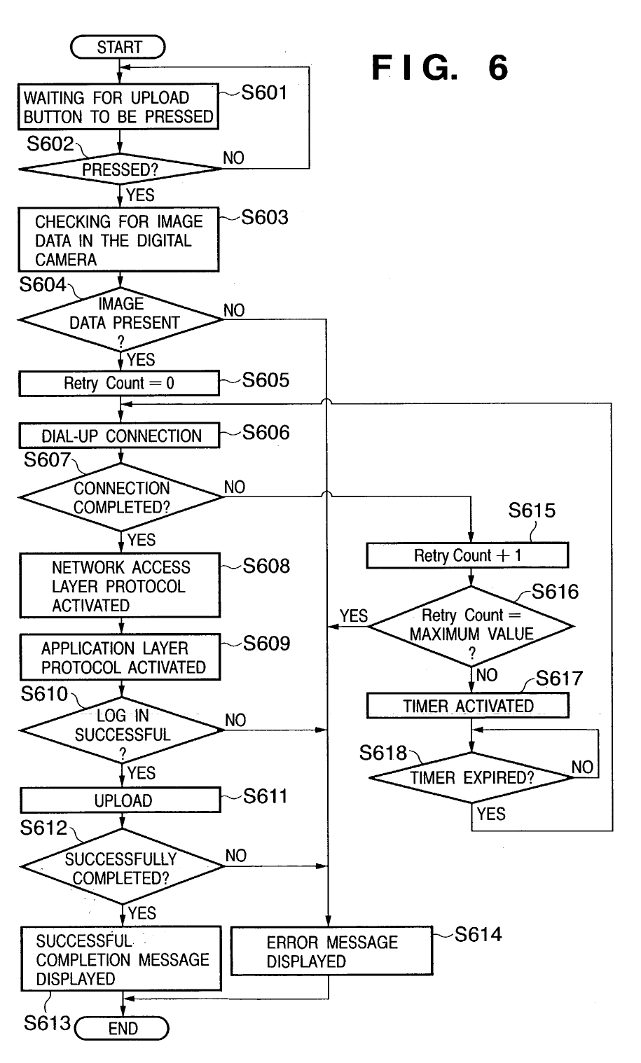

FIG. 6 is a flow chart showing steps in the process of uploading image data to a network server using the communications adapter of the present invention. It is assumed that one of the controls 302 on the communications adapter 101 depicted in FIG. 3 is allocated as an “upload” button, that the communications adapter 101 and the digital camera 102 are connected by the USB cable 305, and that the communications adapter 101 is ready for operation by the user, in a state in which power is supplied to both units (step S601). When the user presses the upload button (YES at step S602), the communications adapter 101 checks the image data storage memory in the digital camera 102 (step S603) and determines whether or not the image data to be uploaded exists (step S604).

It should be noted that the image data in the digital camera 102 is stored in a file format called Design rule for Camera File system (DCF), established by the Japan Electronic Industry Development Association. Further, the digital camera 102 can also select the image data that the user wants to upload from among the DCF-format image data stored in the digital camera 102 and hold the image data in the digital camera 102 as a Digital Print Order Format (DPOF) file. That is, the communications adapter 101 checks the DPOF file image data storage memory in the digital camera 102 and determines whether or not the image data to be uploaded is present

If data to be uploaded is not present, (NO at step S604), then the communications adapter 101 displays on the LCD 303 a message indicating that the image data is not present (step S614) and the upload ends. If the data to be uploaded is present (that is, YES at step S604), the communications adapter 101 begins communicating with the server 109. That is, the communications adapter 101 first resets the dial-up connection Retry Count held in the program to 0 (step S605). Then, the communications adapter 101 attempts a dial-up connection to the telephone number of the AP 106 provided by the ISP (step S606). The telephone number for the AP 106 used for the dialup connection is a telephone number that has been pre-stored in the flash memory 408 of the communications adapter 101.

If the connection fails because the AP 106 does not respond or for some other reason (NO in step S607), then the communications adapter 101 adds 1 to the Retry Count (step S615), checks if the retry count is at the stipulated maximum number of retries (step S616) and, if so (NO at step S616), activates a timer (step S617) and re-attempts a dial-up connection (S606) after a certain period of time has elapsed (step S618). If the retry count is at or over the stipulated maximum number of retries (YES at step S616), the communications adapter 101 displays at the LCD 303 a message indicating that the dial-up connection has failed (step S614) and the upload ends.

If the dial-up connection succeeds (that is, YES at step S607), the communications adapter 101 activates the network access layer protocol (step S608). That is, the PPP transmits the user name and password to the ISP for mutual recognition. Once the PPP connection is established, the TCP/IP is activated. It should be noted that the user name and password used at this time are pre-stored in the flash memory 408 of the communications adapter 101.

Next, the communications adapter 101 activates the HTTP that is the application layer protocol and transmits the user ID and password pre-stored in the flash memory 408 to the server 109, which should be accepted (step S609). At this time, the server 109 checks the user ID and password sent from the communications adapter 101 against the user ID and password it holds in order to determine whether or not to allow the user to log in.

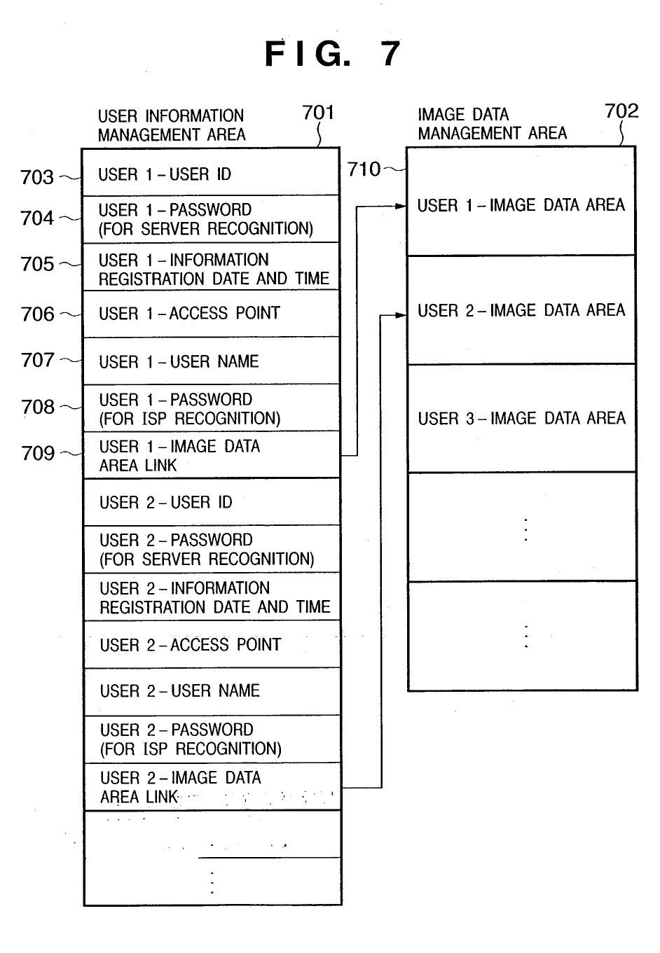

A description is now given of the user ID and password held by the server 109, with reference to FIG. 7.

FIG. 7 is a schematic diagram of the area for managing user information and image data held in the server in the present invention.

As shown in the diagram, a user information management area 701 stores, on a per-user basis, information pertaining to users who are allowed to log in to the server 109. This user information management area 701 exists as a file on a hard disk drive (HDD) attached to the server 109. The user information management area 701 contains a user ID 703 and a password 704, which the server 109 reads from the HDD in order to determine whether or not to allow log-in. In addition, the server 109 also has an image data management area 702 on the HDD as well, with the server 109 storing image data uploaded from the communications adapter 101 in an image data area 710 in the image data management area 702. In order to link the stored image data with the appropriate user, an image data area link 709 is provided to hold link information to the image data area 710 for each user. Further, the user information management area 701 also contains information registration date and time 705, AP 706, user name 707 and user password (for ISP recognition) 708.

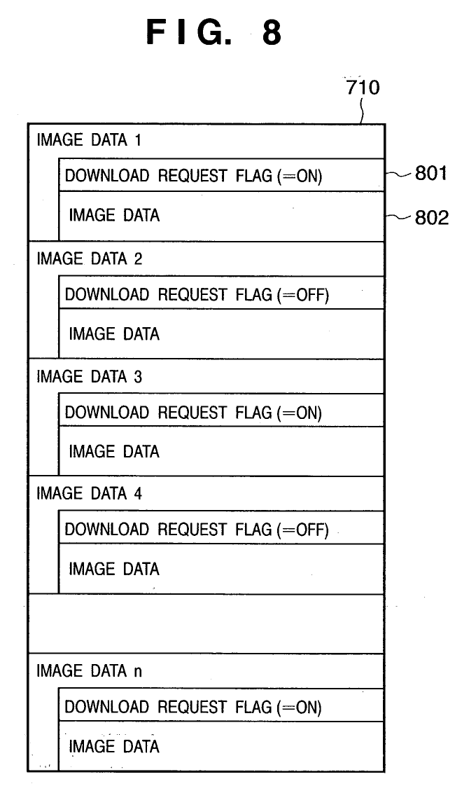

A description is now given of the internal structure of the image data area 710, with reference to FIG. 8.

FIG. 8 is a schematic diagram of the internal structure of the image data area of the present invention.

The image data area 710 is divided into blocks containing individual pieces of image data in the form of image data 1, image data 2, image data 3 . . . image data n. The individual blocks in turn are composed of two data elements: a download request flag 801 and an image data storage area 802.

A description is now given of the process of uploading image data to the server 109 using the communications adapter 101, with reference to FIG. 6.

If for some reason the verification request put to the ISP or server 109 to authorize log-in access fails (that is, NO at step S610), the communications adapter 101 displays at the LCD 303 a message to that effect, i.e., indicating a login failure (step S614) and the upload ends. On the other hand, if above-described log-in access succeeds (YES at step S610), the communications adapter 101 uploads the image data read from the digital camera 102 to the server 109 (step S611). The server 109 then stores the image data in the image data area 710 described above and sends the communications adapter 101 a message indicating that image data storage is completed. When the communications adapter 101 receives the message indicating that image data storage is completed from the server 109, the communications adapter 101 determines that the upload has succeeded (YES at step S612) and displays a message at the LCD 303 to that effect, i.e., that the upload is successful (S613), thus ending the upload. However, if the communications adapter 101 receives a message from the server 109 indicating that image data storage has failed, or if the communications adapter 101 receives no response from the server 109 within a certain period of time (that is, NO at step S612), the communications adapter 101 displays at the LCD 303 a message indicating that the upload has failed (step S614), whereupon the upload ends.

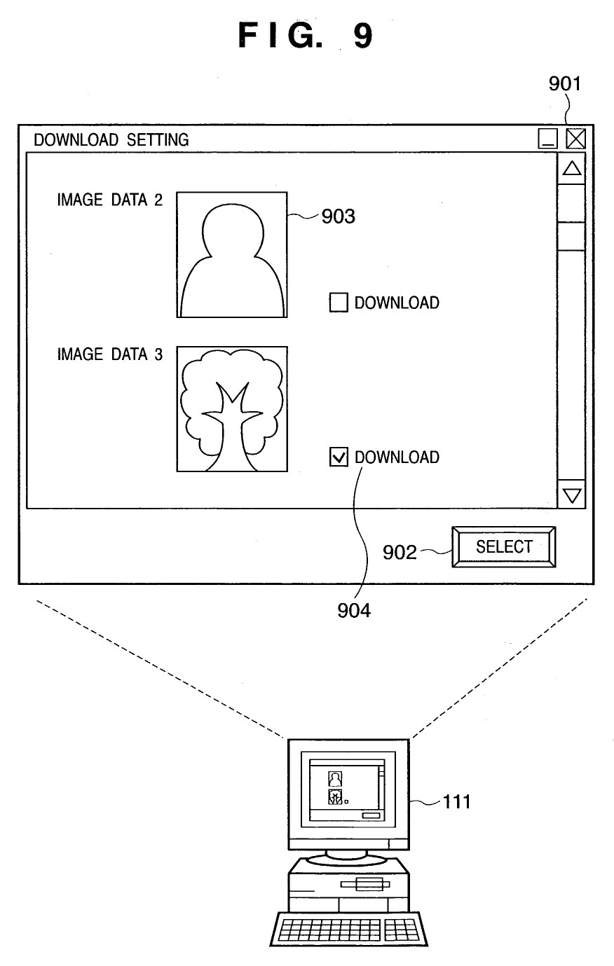

Next, a description is given of the process of downloading image data stored in the Internet 107 server 109 to a digital camera 102 connected to the communications adapter 101 using a PC 111 equipped with a Web browser or a wireless communications terminal 110, with reference to FIG. 9.

First, the user accesses the server 109 using the PC 111 equipped with a Web browser or the wireless communications terminal 110 and makes a download request. For illustrative purposes only, the description given below uses the example of downloading from the PC 111.

FIG. 9 shows an example of a display screen displaying, on a PC monitor, image data stored in the server image data area in the present invention.

The PC 111 display screen shown in FIG. 9 depicts a state in which the user is viewing the image data area 710 in the server 109 using a Web browser. This image viewing screen 901 displays image data 903 stored in the image data area 710. To the right of the displayed image data there is a “download” checkbox 904. When the user wishes to download image data in the server 109 to the digital camera 102 connected to the communications adapter 101, the user checks the appropriate “download” checkbox and presses the “Select” button 902, which sets the download request flag 801 corresponding to the image data in the image data area 710 to ON, thus completing the image data download request to the server 109.

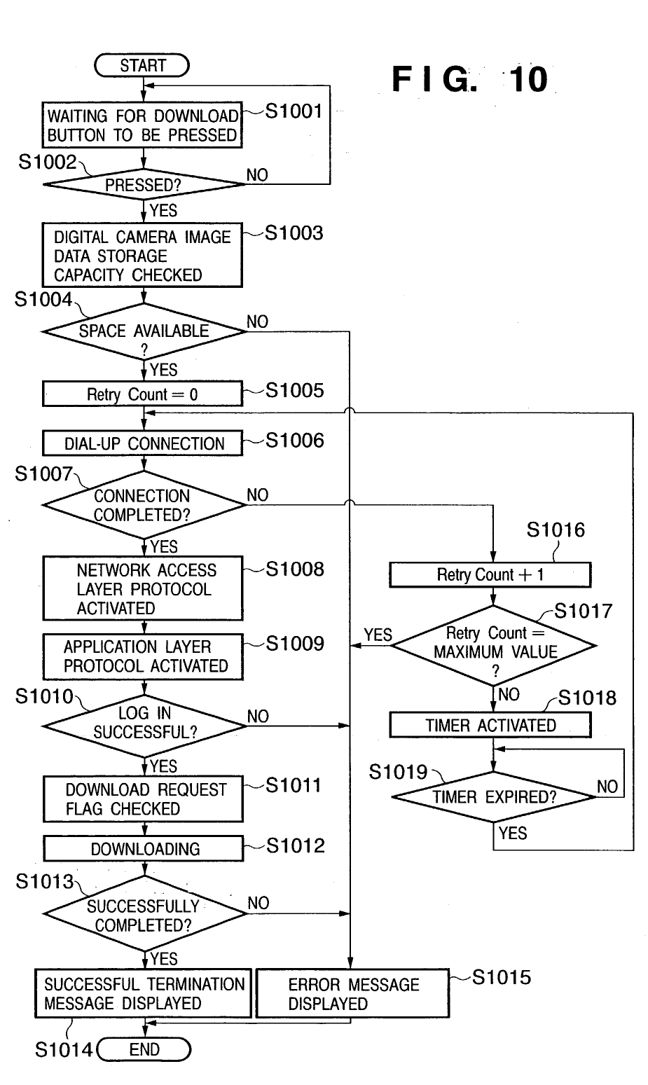

Next, after the download request from the PC 111 described above is completed, the user presses the communications adapter 101 download button to download image data from the server 109 to the digital camera 102, in a process described below with reference to FIG. 10.

FIG. 10 is a flow chart showing steps in a process of downloading image data to a digital camera from a server by the communications adapter of the present invention. It is assumed that one of the controls 302 of the communications adapter 101 depicted in FIG. 3 is allocated as a “download” button.

The process begins at a step S1001 in a state in which the communications adapter 101 and the digital camera 102 are connected to each other by the USB cable 305, and further, that both units have been supplied with power and the communications adapter 101 is ready for operation, in which the controls 302 merely need to be pressed by the user. When the user presses the “Download” button (YES at step S1002), the communications adapter 101 checks the image data storage memory in the digital camera 102 (step S1003) in order to determine whether or not there is enough memory capacity to store the downloaded image (step S1004).

If sufficient memory for image storage cannot be secured (that is, NO at step S1004), the communications adapter 101 displays a message to that effect on the LCD 303 (step S1015) and the download ends. On the other hand, if sufficient memory space for storing the downloaded image can be found (that is, YES at step S1004), the communications adapter 101 performs a dial-up connection, moving the process forward until login is successful (steps S1005-S1010).

The server 109 now searches the server 109 image data area 710, the download request flag 801 is set to “ON” and the server searches for the image data management area 702 in which the image data 802 is stored (step S1011). If the image data management area image 702 is found, the image data in that image data management area image 702 is downloaded to the communications adapter 101 (step S 1012). The communications adapter 101 then stores the downloaded image data in the digital camera 102 image data storage memory and displays on the LCD 303 a message indicated that image data download has been successfully completed (step S1014), thus completing the download.

However, if the download of image data from the server 109 fails, or if there is a failure in the storage of the image data in the image data storage memory of the digital camera 102 (i.e., NO at step S1013), then the communications adapter 101 displays a message at the LCD 303 to that effect, i.e., indicating that the download has failed (step S1015), whereat the download ends.

As described above, according to the present embodiment, when the server 109 image data is downloaded to the digital camera 102, the user selects a desired image using an information processing apparatus such as a Web browser-equipped PC or cellular telephone, so there is no longer any need to provide a means (e.g., a Web browser, an image selector, etc.) of selecting the image data on the server 109 at the communications adapter 101 side. As a result, the cost of manufacturing the communications adapter 101 can be held down.

It should be noted that, when uploading image data to the server 109 from the digital camera 102 via the communications adapter 101, it is acceptable to upload low-resolution image data (hereinafter referred to as thumbnail image data) without uploading high-resolution image data taken by the digital camera 102 (hereinafter referred to as original image data), and uploading original image data only after receiving a request to do so from the viewer.

A description is now given of steps in the process of the communications adapter 101 uploading thumbnail image data in the digital camera 102 to the Internet 107 server 109.

The controls 302 on the communications adapter 101 shown in FIG. 3 include a “Thumbnail image data upload” button and an “Original image data upload” button. If, for example, the user wishes to upload thumbnail image data in the digital camera 102 to the server 109, the user presses the “Thumbnail image data upload” button at step S602 in FIG. 6.

Next, the communications adapter 101 checks for the presence of thumbnail image data in the digital camera 102 (step S603) and, if thumbnail image data to be uploaded is present, 101 logs in to the Internet 107 server 109 via steps S604-610. The thumbnail image data read from the digital camera 102 is then sent to the server 109 for uploading (step S611). When uploading is successfully completed, a message to that effect is displayed on the LCD 303 (step S613) and the upload ends.

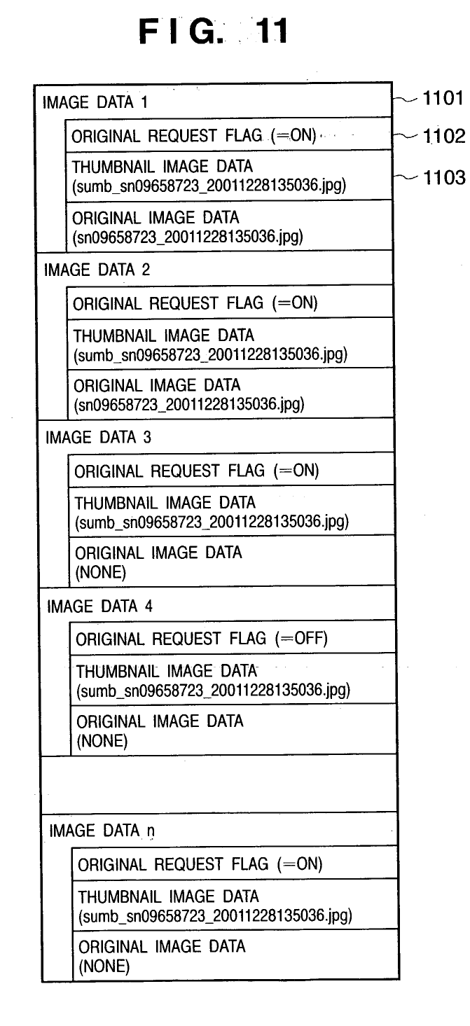

A description is now given of the process by which a user, having viewed thumbnail image data uploaded to the server 109 using a Web browser-equipped PC 111 or wireless communications terminal 110, now wishes to download the original image data corresponding to that thumbnail image data, with reference to FIG. 11.

FIG. 11 is a schematic diagram of the internal structure of the image data area according to one embodiment of the present invention. As shown in the diagram, the image data area is divided into blocks containing individual pieces of image data in the form of image data 1, image data 2, image data 3 . . . image data n. The individual blocks in turn are composed of three data elements: an original image data request flag 1101, a thumbnail image data storage area 1102 and an original image data storage area 1103.

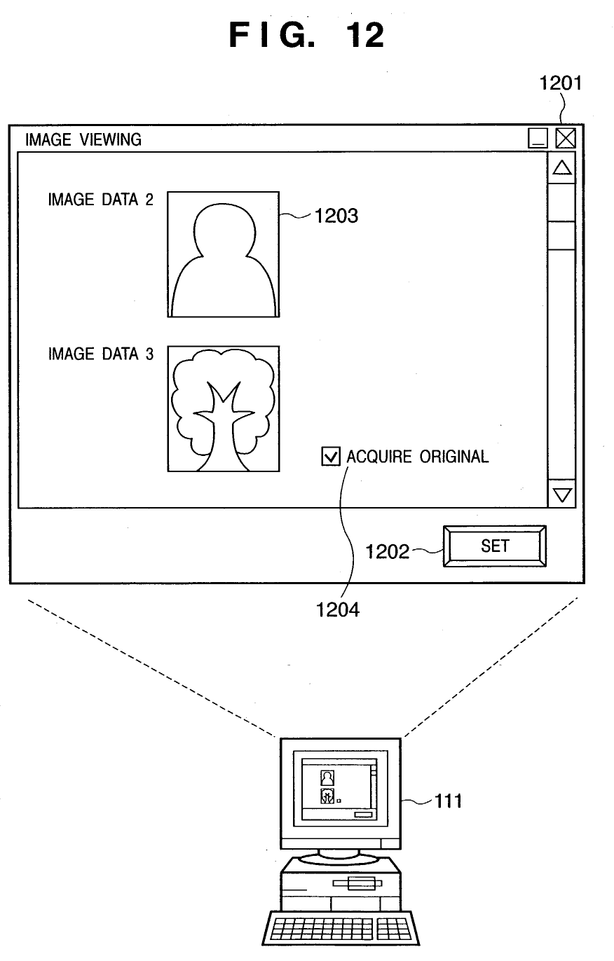

Next, a description is given of the operation of the server 109 in response to a request to upload original image data, with reference to FIG. 12.

FIG. 12 shows an example of a display screen displaying on a PC monitor image data stored in the server image data area in the present invention. The display screen depicted in FIG. 12 shows a state in which the user is viewing an image data area on the server 109 using a Web browser application. The image viewing screen 120 thus shown displays thumbnail image data 1203 stored in the image data area. Where there is no original image data, an “acquire original” checkbox is displayed at the right of the displayed thumbnail image data. When the user wishes to acquire the original image, the user checks the appropriate “Acquire Original” 1204 checkbox and presses the “Select” button 1202, which sets the original request flag 1401 corresponding to the thumbnail image data in the image data area 710 to ON. The communications adapter 101 then receives the request to upload original image data from the server 109 via a network such as the Internet or via a communications network, whereupon a message to that effect is displayed at the LCD 303 in order to notify the user.

When the user presses the “original image data upload” button on the communications adapter 101, the communications adapter 101 makes a dialup connection to the Internet 107 server 109 and logs in to the server 109. Then, the original image data corresponding to the file name of the thumbnail image data for which the original request flag 1101 has been set to ON in the above-described image data management area is read from the digital camera 102 and uploaded to the server 109.

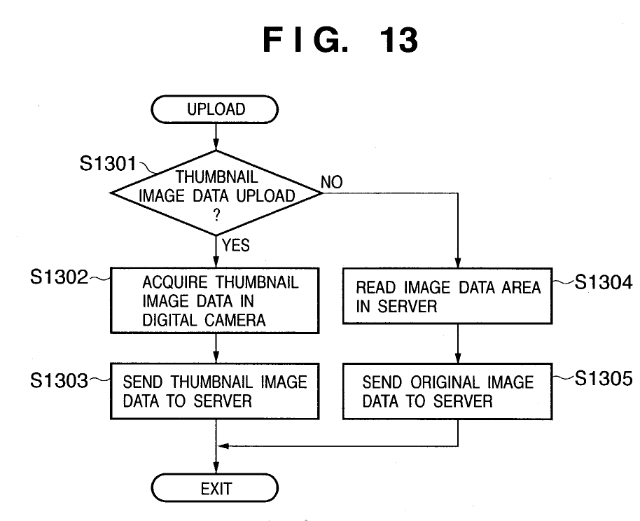

The process of uploading the image data to the server 109 is described below, with reference to FIG. 13.

FIG. 13 is a flow chart showing steps in a process of uploading image data to a network server using the communications adapter of the present invention.

As shown in the flow chart, first the communications adapter 101, in a step S1301, determines whether to upload thumbnail image data or original image data. This determination is informed by whether the user has pressed the “Thumbnail image data upload” button or the “Original image data upload” button. If the “Thumbnail image data upload” button has been pressed, the process proceeds to a step S1302, the thumbnail image data is read from the digital camera 102, and, in a step S1303, the thumbnail image data is uploaded to the server 109.

If in step S1301 the “Original image data upload” button has been pressed, the process proceeds instead to a step S1304, original image data corresponding to the image for which the original request flag 1101 has been set to ON in the server 109 is read out from the digital camera 102, and, in a step S1305, the original image data is uploaded to the server 109.

Thus, uploading original image data of only those images the user wishes to download as described above eliminates unnecessary uploads of original image data and makes it possible to limit the generation of unneeded transmission costs.

As can be appreciated by those of ordinary skill in the art, although in the present embodiment the communications adapter 101 is outside the digital camera 102 and connected by a USB cable for sending and receiving image data, the present invention is not limited to such an embodiment but can also encompass a case in which the communications adapter 101 is built into the digital camera 102 and data is sent and received via a system bus inside the digital camera 102.

In addition, although the present embodiment is described using the example of uploading thumbnail image data corresponding to the original image data, the present invention is not limited to thumbnail image data but can also upload image data of different types, such as, for example, black-and-white image data.

Also, although the present embodiment is described using image data as an example, as can be appreciated by those of ordinary skill in the art, the present invention is not limited to image data but can be adapted to other types of data as well, including audio data.

In addition, the present invention may be implemented by either a system comprising a plurality of devices, such as a host computer, an interface device, a scanner, a printer or the like, or by an apparatus consisting of a single device, such as a copier, facsimile machine or the like.

It should be noted that a software program for implementing the capabilities of the above-described embodiment, supplied either directly from a recording medium or by using wire or wireless communications, to a system or apparatus having a computer capable of executing such program, the execution of such program by the computer of the system or apparatus achieving equivalent capabilities of the above-described embodiments, is included in the present invention.

Accordingly, a program supplied to and installed in such a computer for the purpose of implementing the functional processes of the present invention itself achieves the present invention. That is, a computer program for implementing the processes performed by the present invention is itself included within the present invention.

In such a case, provided the program capabilities are present, the format of the program, whether executed by object code or by an interpreter, for example, does not matter.

The recording media for supplying the program include, but are not limited to, magnetic recording media such as a floppy disk, a hard disk or magnetic tape, optical or magneto-optical recording media such as MO, CD-ROM, CD-R, CD-RW, DVD-ROM, DVD-R or DVD-RW, or a non-volatile semiconductor memory.

As can be appreciated by those of ordinary skill in the art, in addition to implementing the capabilities of the above-described embodiments by reading out and executing the above-described program by computer, the above-described capabilities of the embodiments described above can also be implemented by Operating System (OS) software running on a computer and performing some or all of the actual processes described heretofore based on the program instructions.

Moreover, the present invention also includes an instance in which the above-described capabilities of the embodiments described above are achieved by processes executed in whole or in part by a CPU or the like provided in a function expansion card or a function expansion unit based on program code instructions, after the program code read from the recording medium is written to a memory provided in such a function expansion card inserted into the computer or such a function expansion unit connected to the computer.

The present invention is not limited to the above-described embodiments, and various changes and modifications can be made within the spirit and scope of the present invention. Therefore, in order to apprise the public of the scope of the present invention, the following claims are made.

What is claimed is:

1. An application server adapted to provide a service for storing data via a network, the application server comprising:
a receiver adapted to receive first data from a communications adapter via a network;
a selection unit adapted to select one or more first data from among the first data received; and
an instruction unit for instructing the communications adapter to upload to the application server second data corresponding to the first data selected,
wherein the data size of the first data is smaller than the data size of the second data.

2. The application server according to claim 1, further comprising:
a unit adapted to output a page data to showing the first data to the network.

3. The application server according to claim 1, further comprising:
a unit adapted to forward the uploaded second data to the communication adapter.

4. The application server according to claim 1, wherein:
the communications adapter is either capable of communicating with an image input apparatus or is built into the image input apparatus;
the first data being thumbnail image data of an image input by the image input apparatus; and
the second data being original image data of an image input by the image input apparatus.

5. A method of providing a service for storing data via a network, the method comprising the steps of:
receiving first data from a communications adapter via a network;
selecting one or more first data from among the first data received; and
instructing the communications adapter to upload to an application server second data corresponding to the first data selected,
wherein the data size of the first data is smaller than the data size of the second data.

6. A program adapted to implement on a computer a method of providing a service for storing data via a network and to cause the computer to function as an application server, the program comprising:
a receiving module adapted to receive first data from a communications adapter via a network;
a selection module adapted to select one or more first data from among the first data received; and
an instruction module for instructing the communications adapter to upload to the application server second data corresponding to the first data selected,
wherein the data size of the first data is smaller than the data size of the second data.

7. A communications adapter adapted to be capable of communicating via a network with an application server for providing a service for storing data via a network, the communications adapter comprising:
an upload unit adapted to upload a first data to the application server; and
an instruction receiver adapted to receive an instruction to upload second data corresponding to one or more first data selected from among the first data uploaded,
wherein the upload unit uploads the second data designated by the instruction to the application server.

8. The communication adapter according to claim 7, further comprising:
a communication unit adapted to communicate with an apparatus or is built into the apparatus;
a receiver unit adapted to receive the uploaded second data from the application server; and
a transmitter unit adapted to forward the uploaded second data to the apparatus.

9. The communication adapter according to claim 7, further comprising:
a communication unit adapted to communicate with an image input apparatus or is built into the image input apparatus;
the first data being thumbnail image data of an image input; and
the second data being original image data of an image input.

10. A communications adapter control method for controlling a communications adapter capable of communicating with an application server adapted to provide a service for storing data via a network, the method comprising the steps of:
uploading the first data to the application server;
receiving an instruction from the application server to upload the second data corresponding to one or a more first data selected from among the first data uploaded; and
uploading the second data to the application server.

11. A program for causing a computer to implement a communications adapter control method for controlling a communications adapter capable of communicating with an application server adapted to provide a service for storing data via a network, the program comprising:
a first data uploading module adapted to upload the first data to the application server;
a receiving module adapted to receive an instruction from the application server to upload the second data corresponding to one or a more first data selected from among the first data uploaded; and
a second data uploading module adapted to upload the second data to the application server.

12. A network system adapted to providing a service for storing data via a network, the network system comprising:
a communications unit adapted to transmit a first data from a communications adapter to an application server via the network;
a selection unit adapted to select one or more first data from among the first data; and
an instruction unit for instructing the communications adapter to upload to the application server second data corresponding to the first data selected,
wherein the data size of the first data is smaller than the data size of the second data.
